(19) United States
(12) Patent Application Publication
(10) Pub. No.: US 2008/0096518 A1
(43) Pub. Date: Apr. 24, 2008

(54) OVERRIDING TELECOMMUNICATION QUIET ZONE DEFAULTS FOR EMERGENCY CONTACT LIST COMMUNICATIONS

(75) Inventors: VON A. MOCK, BOYNTON BEACH, FL (US); ERIC T. EATON, LAKE WORTH, FL (US); JUAN C. FERNANDEZ, BOCA RATON, FL (US)

Correspondence Address: PATENTS ON DEMAND, P.A., 4581 WESTON ROAD, SUITE 345, WESTON, FL, 33331, US

(73) Assignee: MOTOROLA, INC., SCHAUMBURG, IL (US)

(21) Appl. No.: 11/551,797

(22) Filed: Oct. 23, 2006

(51) Int. Cl. H04M 11/04

(52) U.S. Cl. 455/404.1

(57) ABSTRACT

The present invention discloses a solution that establishes an emergency contact list, which includes at least one contact. The emergency contact list can be associated with a mobile device capable of wireless communications. The mobile device can be placed within a quiet zone that restricts wireless communications capabilities of the mobile deice while the mobile device is within the quiet zone. A communication attempt can be detected that involves the mobile device and a second device used by a communication participant. When the communication participant is included within the emergency contact list, at least one emergency communication action can be automatically performed. The emergency communication action can provide a communication capability for a communication conducted responsive to the communication attempt that is a capability denied for communications where the communication participant is not included in the emergency contact list. For example, the emergency contact action can enable an otherwise prohibited communication.

### BACKGROUND

1. Field of the Invention

The present invention relates to mobile telecommunications and, more particularly, to overriding telecommunication quiet zones for communications involving parties included in an emergency contact list.

2. Description of the Related Art

Mobile telephone users often find themselves in areas where mobile communications are inappropriate. These areas can be referred to as telecommunication quiet zones. An example of quiet zones can include restaurants, theaters, must halls, seminars, meeting rooms, airplanes, and places of worship. Even courteous users often forget to disable audible ringing features on their phones and fine themselves embarrassed when their phones unexpectedly ring at an inopportune time.

A number of approaches have been attempted to establish and/or enforce quiet zones to control abuses of mobile telephones and other mobile communication devices. These approaches include jamming, blocking, intervention, and detection. Jamming involves devices that emit electromagnetic (EM) signals in frequency ranges of the public mobile communication systems and results in causing mobile communication devices within a quiet zone to act as if the devices were in a “no service area.” Blocking involves shielding an area from EM radiation and can have the same net result as jamming.

Intervention involves making an automatic change to a mobile device and/or to a mobile communications network to limit or alter communication settings while a mobile device is located within a quiet zone. Using one intervention technique, a mobile telephone can be removed from a standard wireless phone network and placed within a private network, where it is unable to receive or transmit calls whenever the mobile telephone is located in a defined quiet zone. Using another intervention technique, settings of a mobile telephone can automatically be adjusted to prevent audible ringing when the mobile device is in a quiet zone. These settings can automatically revert to normal when the mobile telephone leaves a quiet zone.

Detection is a technique that detects a presence or use of mobile telephones within a quiet zone, which can trigger an alarm. The alarm can be designed to inform the device user and/or a security agent of the unauthorized presence or use of a mobile device within the quiet zone so that corrective actions can be taken.

Regardless of which techniques are used to establish and/or enforce a telecommunication quiet zone, no conventional implementation is currently sensitive to potentially emergency communications between a device user and a party included in an emergency contact list. For example, when a parent whose child is being supervised by a baby sitter is located within a quiet zone, that parent is unable to receive emergency communications. Similarly, when a physician on call is located in a quiet zone, patient specific emergency calls are impeded by conventionally implemented quiet zones.

### SUMMARY OF THE INVENTION

An enhancement to telecommunication quiet zones which permits communications between a mobile communication device user and communication participants included within an emergency contact list to communicate even when the mobile device user is located in a quiet zone. The present invention can maintain a data store that enumerates communication participants included in the emergency contact list. The data store can be accessible by a wireless service provider or other communication controlling entity when a mobile device is in a quiet zone. An emergency communication action can route a call in its entirety, can send contact information about a call, and/or can dynamically translate a call from a voice mode to a quiet communication mode. When a communication participant involved in either an incoming and/or outgoing call is found within the emergency contact list, an emergency communication action can be taken to facilitate communication. When the participant is not found in the list, standard quiet zone policies can be enforced, which may result in a blocked communication.

The present invention can be implemented in accordance with numerous aspects consistent with the material presented herein. For example, one aspect of the present invention can include a method to wirelessly communicate that establishes an emergency contact list including at least one contact. The emergency contact list can be associated with a mobile device capable of wireless communications. The mobile device can be placed within a telecommunication quiet zone that restricts wireless communications capabilities of the mobile device while the mobile device is within the quiet zone. A communication attempt can be detected that involves the mobile device and a second communication device associated with a communication participant. When the communication participant is included within the emergency contact list, at least one emergency communication action can be automatically performed. The emergency communication action can provide a communication capability for a communication conducted responsive to the communication attempt that is a capability denied for communications where the communication participant is not included in the emergency contact list. For example, the emergency contact action can enable an otherwise prohibited communication.

Another aspect of the present invention can include a method for implementing a telecommunication quiet zone. The method can automatically monitor wireless communication attempts involving a mobile device included within a quiet zone and a second communication device associated with a communication participant. An emergency contact list associated with the mobile device can be searched for an entry corresponding to the communication participant. When the entry is found, at least one emergency communication action can be performed. The emergency communication action can provide an enhanced communication capability, which would otherwise not be available to the mobile device.

Still another aspect of the present invention can include a mobile telephony system that permits emergency contact communications to be conducted through a telecommunication quiet zone. The system can include a wireless network, a telecommunication quiet zone, a data store, and a network server element. The wireless network can enable mobile devices to communicate with other devices. The telecommunication quiet zone can inhibit wireless communications conducted via the wireless network from occurring within a defined region. The data store can include an emergency contact list containing at least one emergency contact. The network server element can automatically perform at least one emergency communication action that provides an enhanced communication capability for communications involving a mobile device located in the quiet zone whenever that mobile device communicates with a second communication device of a communication participant, where the communication participant is included in the emergency contact list. The emergency contact list can be specific to the mobile device and contacts included in the emergency contact list can be configurable by a user of the mobile computing device.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

The method detailed herein can also be a method performed at least in part by a service agent and/or a machine manipulated by a service agent in response to a service request.

### BRIEF DESCRIPTION OF THE DRAWINGS

These are shown in the drawings, embodiments which are presently preferred, it being understood, however, that the invention is not limited to the precise arrangements and instrumentalities shown.

FIG. 1 is a schematic diagram of a wireless communication system that allows telecommunication quiet zone defaults to be overridden responsive to emergency contact communications.

FIG. 2 is a flow chart of a method for adjusting quiet zone defaults to favor communications with communication participants included within an emergency contact list.

FIG. 3 is a schematic diagram of an intervention system that permits emergency contact communications to be conveyed through a quiet zone in accordance with an embodiment of the inventive arrangements disclosed herein.

FIG. 4 is a schematic diagram of a jamming/blocking system that permits emergency contact communications to be conveyed through a quiet zone in accordance with an embodiment of the inventive arrangements disclosed herein.

FIG. 5 is a schematic diagram of a detection system that permits emergency contact communications to be conveyed through a quiet zone in accordance with an embodiment of the inventive arrangements disclosed herein.

### DETAILED DESCRIPTION OF THE INVENTION

FIG. 1 is a schematic diagram of a wireless communication system 100 that allows telecommunication quiet zone 110 defaults to be overridden responsive to emergency contact communications. That is, more lenient than normal communication capabilities are permitted within quiet zone 110 when a wireless communication involves mobile device 140 and a contact on list 132. People included in the emergency contact list 132 are able to send communications to device 140 and/or receive communications from device 140, even when the device 140 is in the quiet zone 110. When in a quiet zone 110, wireless telephone services and/or options available to mobile devices are purposefully constrained.

Constraining communications in quiet zone 110 means that capabilities of device 140 in zone 110 are less than the capabilities of device 142 located outside zone 110, assuming devices 140 and 142 normally possess approximately equivalent capabilities when both devices 140-142 are inside zone 110 or when both devices 140-142 are outside zone 110. Outgoing capabilities, incoming capabilities, or both outgoing and incoming capabilities of device 140 can be affected by zone 110. When device 140 leaves zone 110, normal capabilities of device 140 can be automatically and dynamically restored. Similarly, when device 142 enters zone 110, its capabilities can be automatically and dynamically limited.

Numerous approaches exist for creating quiet zone 110, which constrain communications in different manners. These approaches include, but are not limited to, jamming, blocking, intervention, and detection. Jamming involves devices that emit electromagnetic (EM) signals in frequency ranges of a wireless network 120, which result in device 140 being unable to connect to wireless network 120. Blocking involves shielding an area, such as zone 110, from EM radiation and has the same net result as jamming. Intervention involves making an automatic change to settings of mobile device 140 and/or changing a wireless network 120 setting. Detection is a technique that detects a presence or use of mobile device 140 within zone 110, which can trigger an alarm or notification that potentially unauthorized wireless communication activity is occurring in zone 110.

The emergency contact list 132 can be a list including people and numbers to be contacted in emergency situations. For example, the emergency contact list can include numbers for the police, a first department, an ambulance service, a physician, and the like. The emergency contact list 132 can also include a list of people and/or phone numbers who are likely to contact device 140 carrying communicator 150, in case of an emergency. For example, a number dialed by a babysitter watching a child can be on list 132, so that communicator 150 is able to receive incoming calls from the baby sitter even when located in quiet zone 110. Additionally, a call dispatcher's number can be included in list 132 associated with a policeman's mobile device 140 so that the policeman is able to receive emergency dispatches via device 140 when the device 140 is in quiet zone 110.

In one embodiment, the emergency contact list 132 can include In Case of Emergency (ICE) contacts. ICE contacts include contacts established to permit first responders, such as paramedics, firefighters, and police officers, to utilize an incapacitates individual's mobile device 140 to quickly identify and communicate with emergency contacts to obtain important medical information and/or to make emergency decisions for the incapacitated individual.

The emergency contact list 132 can store elements for a name, a phone number, as well as other elements that support optional features for establishing contact when an associated device 140 is in a quiet zone 110. For example, the other elements can determine whether a contact, such as Sally, is to be permitted to send messages into zone 110, to receive one or more messages from zone 110, or both. In another example, an element can provide an alternative number, such as the number shown for “Bob” that is to be dialed in situations where communications with the primary number “123-4567” are impossible. In still another example, a contact, such as “Sue” can be considered an emergency contact for a limited period, such as weekends only.

The emergency contact list 132 can be configured by communicator 150. For example, the contact list 132 can be a special contact book or set of contact entries designated by communicator 150 using an interface of device 140. In one embodiment, one or more of the emergency contact list 132 entries can be automatically added by an entity other than communicator 150. For example, a network provider can automatically and/or dynamically include entries for police, fire department, hospitals, and the like that are local device 140. The required information for these entries can be obtained using directory assistance databases.

The emergency contact list 132 can be stored in data store 130, which can store other device-specific contact lists. Data store 130 can be located in a computing space accessible by wireless network 120 and/or device 140. For example, the data store 130 can be a memory space of a service provider system that provides wireless service to the device 140. The data store 130 can also be a memory space of device 140.

Depending upon implementation specifics of the quiet zone 110, different emergency communication actions may be possible. Some of these actions can require interactions between a service 135 proximately located to the mobile device 140 and the device 140. For instance, when an intervention technique is used for establishing quiet zone 110, the server 136 can communicate quiet zone 110 policies to the mobile device 140, which automatically adjusts settings to conform to these policies. When a quiet zone 110 is established using a jamming, server 135 can be a device able to selectively turn on and off the jamming EM signals in order to permit emergency communications.

In one configuration, quiet zone 110 communications can occur using a wireless network only 120. For example, communicator 154 and 150 can use a two way radio feature of devices 140 and 144 to communicate. Communications can also utilize wired network 122 resources. For instance, communicator 154 can use a line based telephone connected to network 122 to communicate with communicator 150.

As used herein, each of the mobile devices 140, 144 can be any computing device configured to convey messages over network 120 and/or 122. Different communication modes can be available to the devices 140-144, which can include telephone modes, two-way radio modes, instant messaging modes, email modes, video telecommunication modes, co-browsing modes, interactive gaming modes, image sharing modes, and the like. Model devices 140-144 can include mobile telephones, Voice over Internet Protocol (VoIP) phones, two-way radios, personal data assistants, mobile entertainment systems, computing tablets, notebook computers, wearable computing devices, and the like.

Network 120 and 122 can include any hardware/software/and firmware necessary to convey digital content encoded within carrier waves. Digital content can be contained within analog or digital signals and conveyed though data or voice channels. Networks 120 and 122 can include network equipment, such as routers, data lines, hubs, and intermediary services which together form a data or telephony network. Network 120 can include mobile communication components, such as cellular communication towers, two-way radio transceiving components, and the like.

Data store 130 can be a physical or virtual storage space configured to store digital information. Data stores 130 can be physically implemented within any type of hardware including, but not limited to, a magnetic disk, an optical disk, a semiconductor memory, a digitally encoded plastic memory, a holographic memory, or any other recording medium. The data stores 130 can be a stand-along storage unit as well as a storage unit formed from a plurality of physical devices. Additionally, information can be stored within data store 130 in a variety of manners. For example, information can be stored within a database structure or can be stored within one or more files of a file storage system, where each file may or may not be indexed for information searching purposes. Further, data store 130 can utilize one or more encryption mechanisms to protect stored information from unauthorized access.

It should be appreciated that system 100 represents one contemplated embodiment in which emergency contact overrides can be implemented for a telecommunication quiet zone 110. The invention is not to be construed as limited to specific details contained within this illustrative embodiment and derivatives and alternatives to those presented should be considered within the scope of the present invention, which generically discloses a means for adding an emergency contact list based override function to a quiet zone 110.

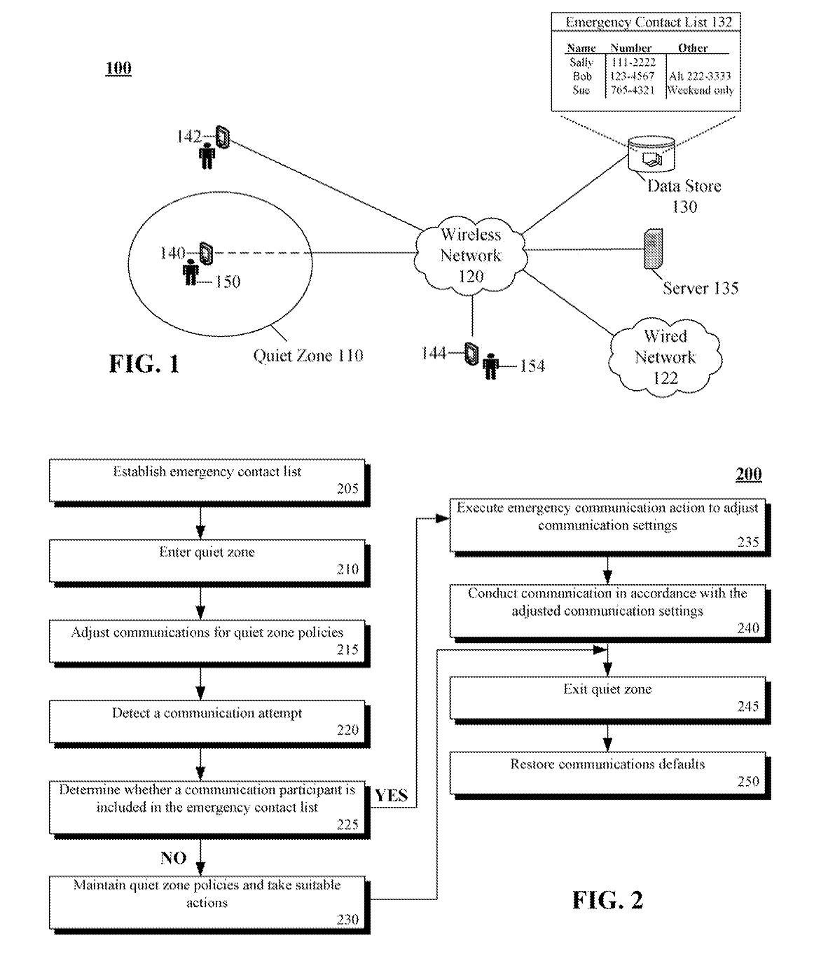

FIG. 2 is a flow chart of a method 200 for adjusting quiet zone defaults to favor communications with communication participants included within an emergency contact list. Method 200 can be performed in the context of system 100, or in the context of any wireless communication system that includes quiet zones.

Method 200 can begin in step 205, where an emergency contact list can be established for a mobile device user. In step 210, the mobile device can enter a quiet zone. If an emergency contact list is stored within the mobile device, it can be automatically conveyed to a data store outside the quiet zone, as necessary to ensure emergency contact list availability. In step 215, settings and/or communication parameters can be adjusted in accordance with quiet zone policies. These adjustments can be made by the mobile device itself, by a server controlling aspects of the quiet zone, and/or by a wireless network that services the mobile device.

In step 220, a communication attempt involving the mobile device can be detected. In step 225, a determination can be made as to whether a remotely located communication participant is included in the emergency list. The communication attempt can be originated by the mobile device or can be originated by a device outside the quiet zone that is trying to communicate with the mobile device.

If the communication participant is not included in the emergency contact list, the method can progress to step 230, where quiet zone policies established in step 215 can be maintained. Suitable actions can be taken based upon these policies. For example, if quiet zone policies do not permit mobile devices to originate cells, an attempted call origination action will fail. The method can proceed from step 230 to step 245, where the mobile device is removed from the quiet zone.

If in step 225, the communication participant is found within the emergency contact list, the method can progress to step 235, where an emergency communication action can be taken. An emergency communication action is any action that adjusts communication properties in a manner that violates quiet zone policies and which facilitates an emergency contact communication. One emergency communication action can route a call involving a device contained in the quiet zone in its entirety, as if the quiet zone did not exist.

Another action can sent contact information and/or summary information through the quiet zone, while not permitting an attempted call to be routed. An indication that outbound calls are blocked can be optionally displayed. This type of action can permit a mobile device user to be aware of an attempted communication so that the user can search for an alternative means to communicate. For example, the user can use a wire line phone located within the quiet zone to return a call that was blocked. The user can also opt to discretely leave the quiet zone, where the mobile device is re-enabled and is able to make outbound calls.

Yet another action can dynamically translate a communication allowing the device inside the quiet zone to communicate using a “quiet” modality. For example, a quiet zone contained device can send and receive text messages, which can be dynamically speech processed to a live speaker using a voice modality. The dynamic speech-to-text and/or text-to-speech translations may result in an additional service charge to a mobile device user. In another embodiment, a caller attempting to contact a communication participant located in a quiet zone can be informed that voice calls are not currently permitted, but that other contact modalities exist. The caller can then opt to communicate using an available modality, such as text messaging.

In step 240, a communication can be conducted in accordance with the adjusted communication settings. In step 245, a mobile device can exit the quiet zone. In step 250, communication defaults can be restored to previous settings. Thus, normal communications involving the mobile device can automatically resume once the mobile device is outside the quiet zone.

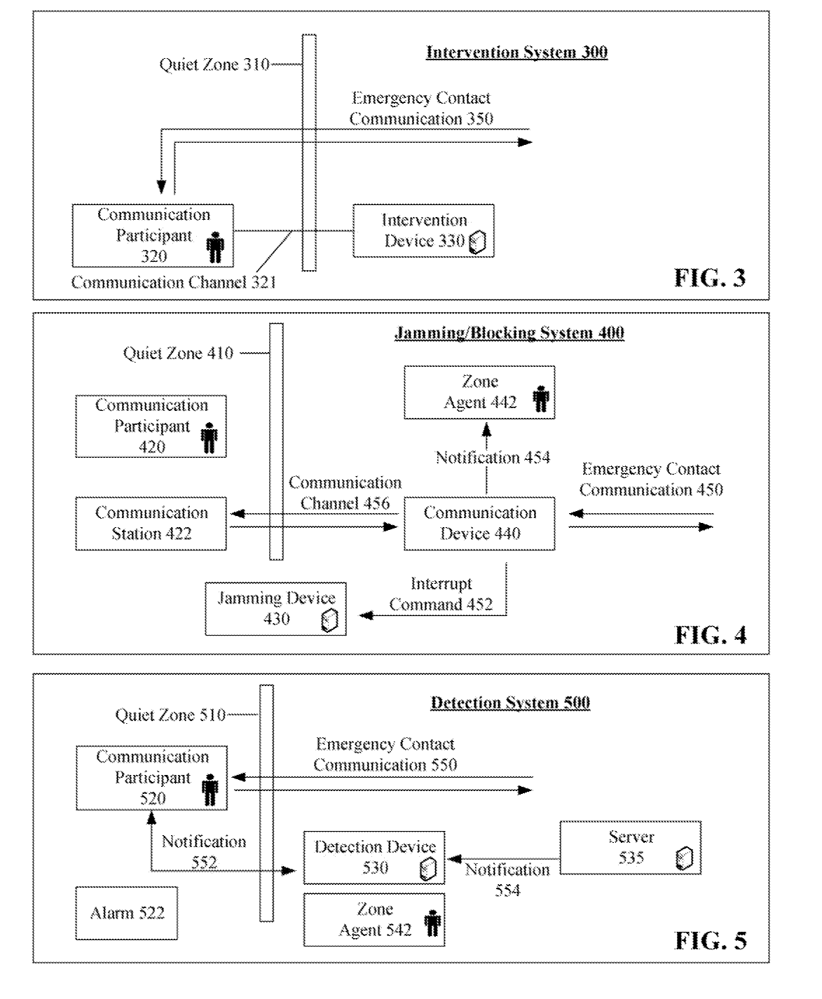

FIG. 3 is a schematic diagram of an intervention system 300 that permits emergency contact communications 350 to be conveyed through a quiet zone 310 in accordance with an embodiment of the inventive arrangements disclosed herein. System 300 can be one contemplated embodiment of system 100, where intervention technology is used to establish a quiet zone 310. The emergency contact communication 350 can be a communication between communication participant 320 and a party included in an emergency contact list.

An intervention technology can involve a direct communication between a communication participant 320 and an intervention device 330. This communication can occur over a communication channel 321, which can be the same channel or a different channel than that over which communication 350 is conveyed. In one configuration, quiet zone 310 protocol settings can be conveyed over communication channel 321 to a mobile device used by communication participant 320. The mobile device can adjust settings, such as ring volume, a wireless telephone enablement state, utilized wireless service network, and the like, responsive to the conveyed settings. When an emergency contact communication 350 is detected, an emergency communication action can be performed. The emergency communication action can cause the intervention device 330 to readjust the settings of the mobile communication device to permit the communication 350 to occur.

Numerous different commercial products exist for establishing an intervention based quiet zone 310. These products can include, but are not limited to, Q-Zone by BluLinx Inc. and Quiet Cell Systems. Q-Zone establishes a BLUETOOTH based channel 321 between a mobile device and intervention device 330 over which commands are conveyed that automatically silence mobile device ringing while in the quiet zone 310. Quiet Cell Systems carry out bi-directional communications with mobile devices over channel 321 to advise mobile devices that they are in a quiet zone 310. The mobile devices are then automatically taken off of a standard phone network and placed within a private network where the mobile device is unable to originate or receive calls.

FIG. 4 is a schematic diagram of a jamming/blocking system 400 that permits emergency contact communications 450 to be conveyed through a quiet zone 410 in accordance with an embodiment of the inventive arrangements disclosed herein. System 400 can be one contemplated embodiment of system 100, where jamming or blocking technology is used to establish a quiet zone 410. The emergency contact communication 450 can be a communication between communication participant 420 and a party included in an emergency contact list.

Free usage of jamming devices 430 is typically restricted in countries that value the EM spectrum as a commercial resource. For example, the United States, which licenses a right to exclusively use portions of the EM spectrum to business entities, protects the rights of these entities by making jamming devices 430 illegal. Commercially sold jamming devices 430 include C-Guard by Netline Technologies of Israel, GSM Silencer by Hi-Tech Electronics of Singapore, GSM Blocker by Starport of England, Mobile Blocker by Image Sensing Systems of the United States, and Wall Wave by Medic Inc. of the United States.

Blocking is an alternative to jamming that has the same net effect as jamming. Blocking involves shielding an area from EM radiation. For example, a Faraday cage can be constructed for a room, such as a conference room or concert hall, which prevents mobile telecommunication signals from entering and exiting the shielded room. Blocking is not generally illegal or restricted in any country and can be a viable, if expensive, means of creating a telecommunication quiet zone 410.

One way to permit emergency contact communication 450 to occur across quiet zone 410 is to temporarily disable the jamming device 430, which can be accomplished by sending an interrupt command 452 to the jamming device 430. Another way is to change a communication frequency used for emergency contact communication 450 from a blocked or jammed frequency to a difference frequency capable of working within the quiet zone 410.

For example, although mobile telephony frequencies can be unavailable for devices in quiet zone 410, wireless IP network frequencies, such as those used for 802.11 protocol communications, can be available. VoIP communications can occur between the mobile communication device and a communication station 422 over the wireless IP frequencies. Station 422 can convey content obtained from the communication device over communication channel 456 to a communication device 440 and is able to communicate to a remotely located communication participant without quiet zone 410 interference. In one configuration, the communication channel 456 can be a line based channel that is unaffected by EM blocking or jamming.

In one contemplated configuration, the communication channel 456 can be a wireless telephone channel, such as a channel in a 2.4 GHz or 5.8 GHz range, which is standard for wireless telephone handsets connected to a base station. The communication device 440 can be a mobile device of the communication participant 420 that receives and/or sends the emergency contact communication 450. This device can be docked to a docking device that dynamically converts mobile telephony communications to normal telephone communications. For example, a MOTOROLA SD4500 series call dock can be used. Before communication participant 420 enters the quiet zone 410 he can be handed a wireless handset communicatively linked to the cell dock. The handset can use a frequency range that is not prohibited by the quiet zone 410. The handset can be deactivated by default for normal incoming communications but can be dynamically activated for incoming emergency contact communications 450. The handset can also be configured to only permit outgoing calls to phone numbers included within the emergency contact list.

In still another contemplated situation, a zone agent 442 can monitor incoming calls made to mobile telephone devices for users in the quiet zone 410. A zone agent can be a human agent or a software agent responsible for enforcing policies of the quiet zone 410, which includes emergency contact policies. For example, system 400 can send a notification 454 to the zone agent 442 when a communication is an emergency contact communication 450. The zone agent 442 can then “enter” the quiet zone and inform the communication participant 420 of the communication 450.

FIG. 5 is a schematic diagram of a detection system 500 that permits emergency contact communications 550 to be conveyed through a quiet zone 510 in accordance with an embodiment of the inventive arrangements disclosed herein. System 500 can be one contemplated embodiment of system 100, where detection technology is used to establish a quiet zone 510. The emergency contact communication can be a communication between communication participant 520 and a party included in an emergency contact list.

System 500 can include a detection device 530 that automatically detects when a mobile device is wirelessly activated and/or used within the quiet zone 510. Detection can result in an alarm 522 sound, in a notification 552 being sent to communication participant 520 and/or in a notification being sent to a zone agent 542. The zone agent can be responsible for enforcing policies established for the quiet zone 510.

Additionally, system 500 can also include an emergency contact server 535, which determines whether a communication attempt involves a party included within an emergency contact list, in which case the server 535 can initiate suitable adjustments. For instance, when an emergency communication 550 is detected by server 535, the server 535 can send a notification 554 to the detection device 530, which disables communication prevention measures for the communication 550. Because communications, such as communication 550, are not disabled across the quiet zone 510, the communication participant 520 is normally able to communicate despite the potential prevention measures that can result from a communication. In one embodiment, a notification 552 can be sent from the mobile device to the detection device 530 to disable these prevention measures for emergency contact communications 550. Thus, a notification 552 from the mobile device of communication participant 520 can serve the same purpose as notification 554 from server 535.

It should be appreciated that the implementations discussed in systems 300, 400, and 500 are for illustrative purposes only and that the invention is not to be construed as limited in this regard. Instead, the examples are shown to illustrate that the general concept of permitting emergency contact communications to be conducted through a quiet zone is possible, regardless of which technology (e.g., intervention, jamming, blocking, and detecting) is used to establish a quiet zone. The examples shown in systems 300, 400, and 500 are not intended to be exhaustive and many other known techniques can be used to enhance communication capabilities of devices in quiet zones for emergency contact communication purposes. For example, each of the systems 300, 400, and 500 can implement all of the emergency contact actions discussed in step 235 of method 200. Specific implementation details will vary depending on which technology is used to establish the telecommunication quiet zone.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method to wirelessly communicate comprising:
establishing an emergency contact list including at least one contact, wherein said emergency contact list is associated with a mobile device capable of wireless communications;
placing the mobile device within a telecommunication quiet zone that restricts wireless communications capabilities of the mobile device while the mobile device is within the quiet zone;
detecting a communication attempt involving the mobile device and a second communication device of a communication participant; and
when the communication participant is included within the emergency contact list, automatically performing at least one emergency communication action, wherein said emergency communication action provides a communication capability for a communication conducted responsive to the communication attempt that is a capability denied for communications where the communication participant is not included in the emergency contact list.

2. The method of claim 1, wherein the emergency contact list is an In Case of Emergency (ICE) list and wherein the at least one contact includes an ICE contact.

3. The method of claim 1, wherein the emergency communication action establishes a communication between the mobile device and the second communication device that is uninhibited by the quiet zone.

4. The method of claim 1, wherein the emergency communication action denies the communication attempt, but conveys contact information relating to at least one of the second communication device and the communication party to the mobile device and provides a notification to the mobile device of the communication attempt.

5. The method of claim 4, wherein the mobile device presents the notification and the contact information along with an indication that outgoing communications from the mobile device are prohibited while the mobile device is in the quiet zone.

6. The method of claim 1, wherein the quiet zone prevents voice modality communications but permits text modality communications involving the mobile device.

7. The method of claim 1, wherein the second communication device and the mobile device communicate with each other using different modalities, wherein a modality used by the mobile device is a quiet modality, and wherein the emergency communication action dynamically translates communicated content from one modality format to another.

8. The method of claim 1, wherein the emergency communication action establishes a communication between the mobile device and the second communication device, wherein text entered into the mobile device is dynamically converted to speech that is presented to the second communication device, and wherein speech provided to the second communication device is dynamically converted to text that is presented upon the mobile device.

9. The method of claim 1, wherein the mobile device is a telephony device and wherein the communication attempt is for a telephone call.

10. The method of claim 1, wherein the emergency contact list is stored in a data store accessible by a network server element of a wireless telephony network that provides mobile telephony service to the wireless device, and wherein the network server element performs the detecting step and initializes the emergency communication action.

11. The method of claim 1, wherein the communication attempt is for an incoming call to the mobile device.

12. The method of claim 1, wherein the communication attempt is for an outgoing call from the mobile device.

13. The method of claim 1, wherein the quiet zone is established using an intervention technology.

14. The method of claim 1, wherein the quiet zone is established using a jamming technology.

15. The method of claim 1, wherein the quiet zone is established using a blocking technology.

16. The method of claim 1, wherein the quiet zone is established using a detecting technology.

17. The method of claim 1, wherein said establishing, detecting, and performing steps of claim 1 are steps performed by at least one machine in accordance with at least one computer program stored within a machine readable memory, said computer program having a plurality of code sections that are executable by the at least one machine.

18. The method for implementing a telecommunication quiet zone comprising:
automatically monitoring wireless communication attempts involving a mobile device included within a quiet zone and a second communication device of a communication participant;
searching an emergency contact list associated with the mobile device for an entry corresponding to the communication participant;
when the entry is found, performing at least one emergency communication action, wherein said emergency communication action provides an enhanced communication capability, wherein said at least one emergency communication comprises at least one action selected from a group of actions comprising an action that establishes a communication between the mobile device and the second communication device that is uninhibited by the quiet zone, an action that denies the communication attempt but conveys contact information for at least one of the second communication device and the communication participant to the mobile device and provides a notification to the mobile device of the communication attempt, and an action that dynamically translates communicated content between a silent modality used by the mobile device and a speech modality used by the second communication device.

19. A mobile telephony system that permits emergency contact communications to be conducted through a telecommunication quiet zone comprising:
a wireless network for enabling mobile devices to communicate with other devices;
a telecommunication quiet zone configured to inhibit wireless communications conducted via the wireless network that occur within a defined region;
a data store communicatively linked to the wireless network that includes an emergency contact list containing at least one emergency contact; and
a network server element communicatively linked to the wireless network configured to automatically perform at least one emergency communication action that provides an enhanced communication capability for communication involving a mobile device located in the quiet zone whenever that mobile device communicates with a communication participant included in the emergency contact list, where the emergency contact list is specific to the mobile device, and wherein contacts included in the emergency contact list are configurable by a user of the mobile computing device.

20. The mobile telephony system of claim 19, wherein said at least one emergency communication comprises at least one action selected from a group of actions comprising an action that establishes a communication between the mobile device and a device of the communication participant that is uninhibited by the quiet zone, an action that denies the communication attempt but conveys contact information relating to at least one of the communication participant and a device used by the communication participant to the mobile device and provides a notification to the mobile device of the communication attempt, and an action that dynamically translates communicated content between a silent modality used by the mobile device and a speech modality used by the device of the communication participant.
